(19) United States
(12) Patent Application Publication
(10) Pub. No.: US 2015/0059812 A1
(43) Pub. Date: Mar. 5, 2015

(54) Vehicle Wash Rack

(71) Applicant: Petter Investments, Inc. d/b/a Riveer Co, South Haven, MI (US)

(72) Inventors: Douglas A. Petter, South Haven, MI (US); Matthew J. Petter, South Haven, MI (US)

(73) Assignee: Petter Investments, Inc. d/b/a Riveer Co, South Haven, MI (US)

(21) Appl. No.: 14/011,288

(22) Filed: Aug. 27, 2013

(51) Int. Cl. B60S 3/04

(52) U.S. Cl. CPC B60S 3/04
USPC 134/123

(57) ABSTRACT

A vehicle wash rack is disclosed. The vehicle wash rack includes a plurality of vehicle supporting floor segments; a plurality of fluid overspray containment wall segments; and a fluid handling system fluidly-connected to both of the plurality of vehicle supporting floor segments and the plurality of fluid overspray containment wall segments.

### FIELD OF THE INVENTION

The disclosure relates to a vehicle wash rack.

### DESCRIPTION OF THE RELATED ART

Washing systems are known in the art. Improvements to washing systems are continuously being sought in order to advance the art.

### BRIEF DESCRIPTION OF THE DRAWINGS

The disclosure will now be described, by way of example, with reference to the accompanying drawings, in which:

FIG. 1 is a perspective view of a vehicle wash rack according to an embodiment.

FIG. 2 is a top view of the vehicle wash rack of FIG. 1.

FIG. 3 is a side view of the vehicle wash rack of FIG. 1.

FIG. 4 is an enlarged view of the vehicle wash rack of FIG. 3 according to line 4.

### SUMMARY

One aspect of the disclosure provides a vehicle wash rack. The vehicle was rack includes a plurality of vehicle supporting floor segments, a plurality of fluid overspray containment wall segments, and a fluid handling system that is fluidly-connected to both of the plurality of vehicle supporting floor segments and the plurality of fluid overspray containment wall segments.

In some examples, the plurality of vehicle supporting floor segments include at least one platform segment and at least one fluid-collecting trough segment.

In some implementations, the at least one platform segment includes a first platform segment, a second platform segment and a third platform segment.

In some instances, the at least one fluid-collecting trough segment includes a first fluid-collecting trough segment and a second fluid-collecting trough segment. The first fluid-collecting trough segment is disposed between the first platform segment and the second platform segment. The second fluid-collecting trough segment is disposed between the second platform segment and the third platform segment.

In some examples, a distal end of the first platform segment is arranged at a higher elevation than the proximal end of the first platform segment in order to arrange the first platform segment at a pitched angle for directing fluid into the first fluid-collecting trough segment. A proximal end of the third platform segment is arranged at a higher elevation a the distal end of the third platform segment in order to arrange the third platform segment at a pitched angle for directing fluid into the second fluid-collecting trough segment.

In some implementations, one or more of the first, second and third platform segments of the at least one platform segment of the plurality of vehicle supporting floor segments may form at least one perforation for permitting fluid to flow through one or more of the first, second and third platform segment of the at least one platform segment of the plurality of vehicle supporting floor segments. The at least one perforation is in fluid communication with one or more of the first fluid-collecting trough segment and the second fluid-collecting trough segment.

In some instances, one or more of the first, second and third platform segments of the at least one platform segment includes at least one vehicle undercarriage fluid spraying nozzle that directs fluid toward an undercarriage of a vehicle.

In some examples, the first and second platform segments of the at least one platform segment each includes a plurality of vehicle undercarriage fluid spraying nozzles that are arranged in a substantially grid-shaped pattern.

In some implementations, the first platform segment includes a grid-shaped pattern of vehicle undercarriage fluid spraying nozzles defined by four columns and eight rows of vehicle undercarriage fluid spraying nozzles.

In some instances, the second platform segment includes a grid-shaped pattern of vehicle undercarriage fluid spraying nozzles defined by three columns and eight rows of vehicle undercarriage fluid spraying nozzles.

In some examples, the plurality of fluid overspray containment wall segments are supported by and extend away from the plurality of vehicle supporting floor segments.

In some implementations, the plurality of fluid overspray containment wall segments include a distal wall segment and a pair of side wall segments defined by a first side wall segment and a second side wall segment.

In some instances, the distal wall segment is attached to and extends away from a distal end of the first platform segment of the at least one platform segment of the plurality of vehicle supporting floor segments. The first side wall segment is attached to and extends away from a first end of each of the first, second and third platform segments and the first and second fluid-collecting trough segments of the of the plurality of vehicle supporting floor segments. The second side wall segment is attached to and extends away from a second end of each of the first, second and third platform segments and the first and second fluid-collecting trough segment of the plurality of vehicle supporting floor segments.

In some examples, the pair of side wall segments define an opening or passage along a proximal end of the third platform segment of the at least one platform segment of the plurality of vehicle supporting floor segments.

In some implementations, one or more of the distal wall segment and the pair of side wall segments of the plurality of fluid overspray containment wall segments includes at least one vehicle side fluid spraying nozzle that directs fluid toward one or more sides of a vehicle and/or wheels of the vehicle.

In some instances, each of the distal wall segment, the first side wall segment and the second side wall segment includes an upper fluid conduit and a lower fluid conduit. Each of the upper fluid conduit and the lower fluid conduit includes a plurality of vehicle side fluid spraying nozzles arranged in a row.

In some examples, the plurality of vehicle supporting floor segments are supported by a frame member.

In some implementations, a fluid-supplying conduit is formed in a thickness of the frame member. The fluid-supplying conduit is fluidly-couples the fluid handling system to both of at least one vehicle undercarriage fluid spraying nozzle attached to the plurality of vehicle supporting floor segments and at least one vehicle side fluid spraying nozzle attached to the plurality of fluid overspray containment wall segments.

In some instances, the fluid handling system includes at least one first fluid container and a pump device including one or more pumps and one or more valves.

In some examples, a first fluid container of the at least one first fluid container contains a cleaning solvent that is delivered to one or more of the at least one vehicle undercarriage fluid spraying nozzle and the at least one vehicle side fluid spraying nozzle by the pump device.

In some implementations, the pump device includes a computing device that controls one or more of the one or more pumps and the one or more valves.

In some instances, a second fluid container of the at least one first fluid container receives a recovered cleaning solvent from the plurality of vehicle supporting floor segments after the cleaning solvent impacts one or more of an undercarriage and one or more sides of a dirty vehicle. The recovered cleaning solvent is delivered to the second fluid container by the pump device.

In some examples, the computing device controls the one or more pumps for controlling a flow rate of the cleaning solvent jetted from one or more of the at least one vehicle undercarriage fluid spraying nozzle attached to the plurality of vehicle supporting floor segments and the at least one vehicle side fluid spraying nozzle attached to the plurality of fluid overspray containment wall segments.

In some implementations, the computing device controls the one or more pumps for controlling a fluid pressure of the cleaning solvent jetted from one or more of the at least one vehicle undercarriage fluid spraying nozzle attached to the plurality of vehicle supporting floor segments and the at least one vehicle side fluid spraying nozzle attached to the plurality of fluid overspray containment wall segments.

In some instances, the computing device controls the one or more valves for controlling a sequencing of the one or more of the at least one vehicle undercarriage fluid spraying nozzle attached to the plurality of vehicle supporting floor segments and the at least one vehicle side fluid spraying nozzle attached to the plurality of fluid overspray containment wall segments.

### DETAILED DESCRIPTION OF THE INVENTION

The Figures illustrate an exemplary embodiment of a vehicle wash rack in accordance with an embodiment of the invention. Based on the foregoing, it is to be generally understood that the nomenclature used herein is simply for convenience and the terms used to describe the invention should be given the broadest meaning by one of ordinary skill in the art.

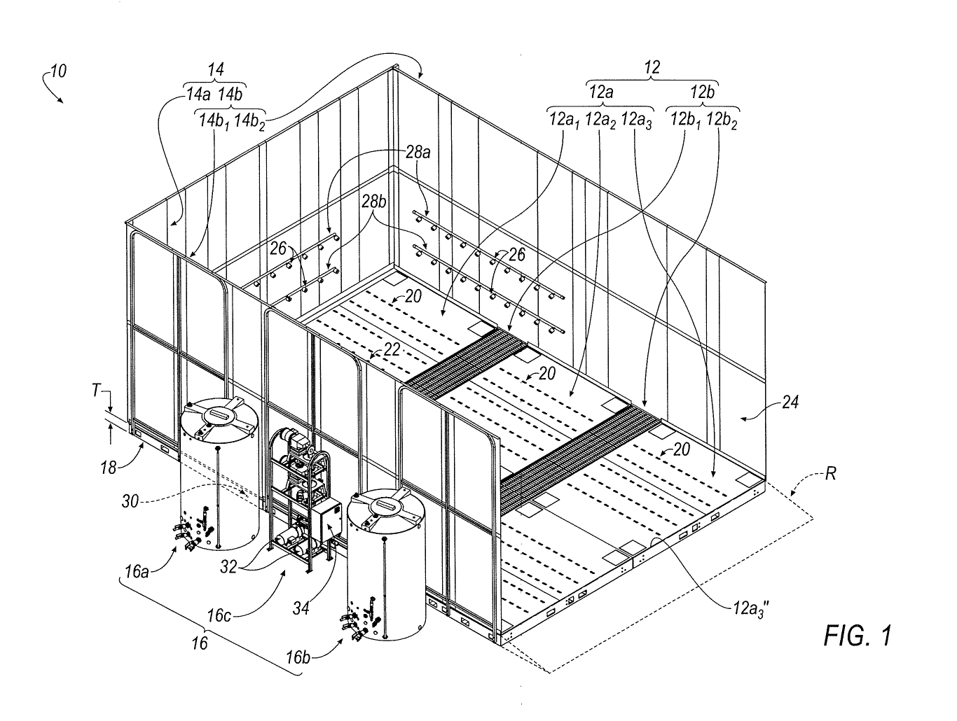

A vehicle wash rack for washing a vehicle (not shown) is shown generally at 10 at FIG. 1 according to an embodiment of the invention. The vehicle may include, but is not limited to: a car, truck, motorcycle, or the like. Although a land vehicle (e.g., a car, truck, motorcycle or the like) may be utilized in conjunction with the vehicle wash rack 10, the vehicle wash rack 10 may treat other vehicles including, but not limited to: aircrafts or sea vehicles, such as, for example, airplanes, helicopters, boats or the like.

The vehicle wash rack 10 may be commercially available from by Riveer Environmental of South Haven, Mich. The vehicle wash rack 10 may be an integrated and self-contained device that performs several functions in the maintenance (e.g., washing) of a vehicle while mitigating corrosion of the vehicle.

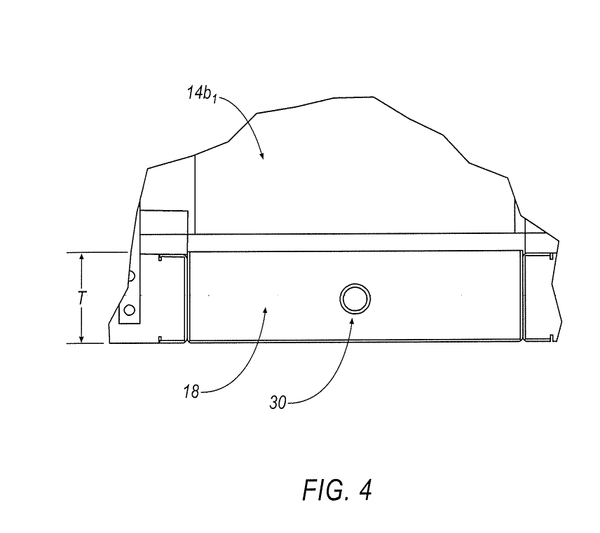

Referring to one or more of FIGS. 1-4, the vehicle wash rack 10 may include a plurality of vehicle supporting floor segments 12 and a plurality of fluid overspray containment wall segments 14. A fluid handling system 16 is fluidly-connected to both of the plurality of vehicle supporting floor segments 12 and the plurality of fluid overspray containment wall segments 14.

The plurality of vehicle supporting floor segments 12 may be supported by a frame member 18 (see, e.g., FIGS. 1-4). The plurality of vehicle supporting floor segments 12 include at least one pervious platform segment 12a and at least one fluid-collecting trough segment 12b.

In an implementation, the at least one pervious platform segment 12a includes a first pervious platform segment 12a₁, a second pervious platform segment 12a₂ and a third pervious platform segment 12a₃. In an implementation, the at least one fluid-collecting trough segment 12b includes a first fluid-collecting trough segment 12b₁ and a second fluid-collecting trough segment 12b₂. Referring to FIG. 1, the first fluid-collecting trough segment 12b₁ may be disposed between the first pervious platform segment 12a₁ and the second pervious platform segment 12a₂, and, the second fluid-collecting trough segment 12b₂ may be disposed between the second pervious platform segment 12a₂ and the third pervious platform segment 12a₃.

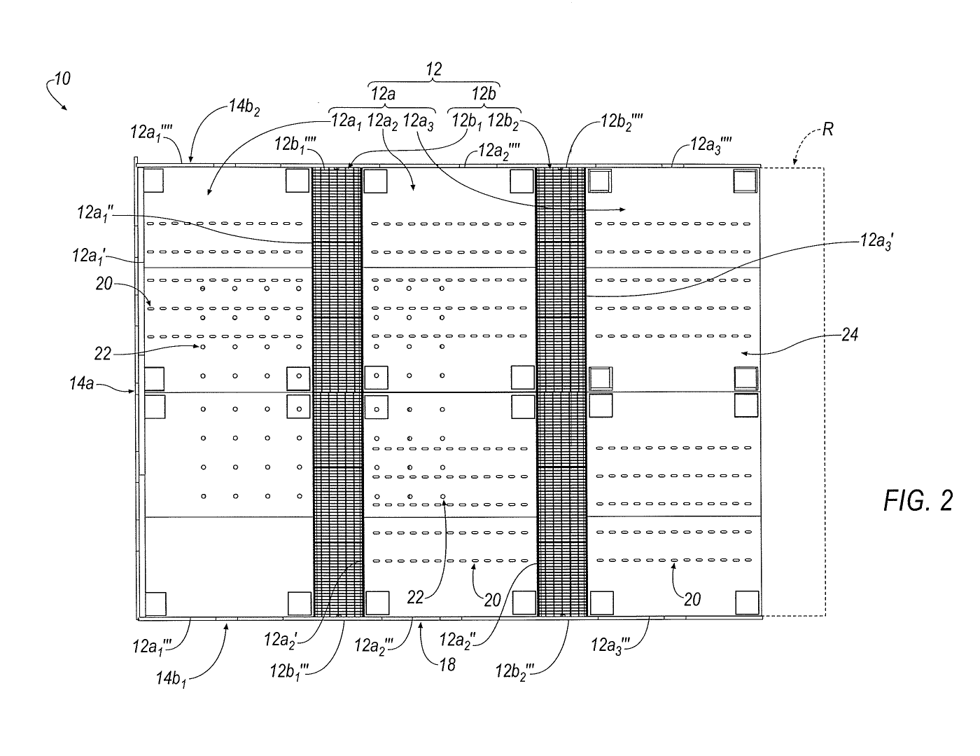

Referring to FIG. 2, a distal end 12a₁′ of the first pervious platform segment 12a₁ may be arranged at a higher elevation than the proximal end 12a₁″ of the first pervious platform segment 12a₁ in order to arrange the first pervious platform segment 12a₁ at a pitched angle for directing fluid into the first fluid-collecting trough segment 12b₁. A proximal end 12a₃″ of the third pervious platform segment 12a₃ may be arranged at a higher elevation than a distal end 12a₃′ of the third pervious platform segment 12a₃ in order to arrange the third pervious platform segment 12a₃ at a pitched angle for directing fluid into the second fluid-collecting trough segment 12b₂. The second pervious platform segment 12a₂ may be arranged at one or more pitched angles for directing fluid into one or both of the first fluid-collecting trough segment 12b₁ and/or the second fluid-collecting trough segment 12b₂; however, in some implementations, the second pervious platform segment 12a₂ may not be arranged at a pitched angle and the fluid may randomly flow into either of the first fluid-collecting trough segment 12b₁ and/or the second fluid-collecting trough segment 12b₂.

Referring to FIGS. 1-2, in an implementation, one or more of the first, second and third pervious platform segments 12a₁, 12a₂, 12a₃ of the at least one pervious platform segment 12a of the plurality of vehicle supporting floor segments 12 may form at least one perforation 20 for permitting fluid to flow through one or more of the first, second and third pervious platform segment 12a₁, 12a₂, 12a₃ of the at least one pervious platform segment 12a of the plurality of vehicle supporting floor segments 12. The at least one perforation 20 may direct the fluid into a channel (not shown) formed within a thickness, T (see, e.g., FIGS. 1 and 3-4), of the frame member 18; the channel may be in fluid communication with the at least one perforation 20 of one or more of the first, second and third pervious platform segments 12a₁, 12a₂, 12a₃ in order to permit the fluid to be directed from the one or more of the first, second and third pervious platform segments 12a₁, 12a₂, 12a₃ to the first fluid-collecting trough segment 12b₁ and/or the second fluid-collecting trough segment 12b₂.

Referring to FIGS. 1-2, in an implementation, one or more of the first, second and third pervious platform segments 12a₁, 12a₂, 12a₃ of the at least one pervious platform segment 12a may include at least one vehicle undercarriage fluid spraying nozzle 22 that directs fluid toward an undercarriage of a vehicle (not shown). Referring to FIG. 2, the first and second pervious platform segments 12a₁, 12a₂ may each include a plurality of vehicle undercarriage fluid spraying nozzles 22 that are arranged in a substantially grid-shaped pattern. In an example, the first pervious platform segment 12a₁ may include a grid-shaped pattern of vehicle undercarriage fluid spraying nozzles 22 defined by four columns and eight rows of vehicle undercarriage fluid spraying nozzles 22. In an example, the second pervious platform segment 12a₂ may include a grid-shaped pattern of vehicle undercarriage fluid spraying nozzles 22 defined by three columns and eight rows of vehicle undercarriage fluid spraying nozzles 22.

Referring to FIG. 1, the plurality of fluid overspray containment wall segments 14 may be supported by and extend away from the plurality of vehicle supporting floor segments 12. In an example, the plurality of fluid overspray containment wall segments 14 include a distal wall segment 14a and a pair of side wall segments 14b defined by a first side wall segment 14b₁ and a second side wall segment 14b₂.

Referring to FIG. 2, the distal wall segment 14a is attached to and extend away from the distal end 12a₁′ of the first pervious platform segment 12a₁ of the at least one pervious platform segment 12a of the plurality of vehicle supporting floor segments 12. The first side wall segment 14b₁ may be attached to and extend away from a first end 12a₁′″, 12a₂′″, 12a₃′″, 12b₁′″, 12b₂′″ of each of the first, second and third pervious platform segments 12a₁, 12a₂, 12a₃ and the first and second fluid-collecting trough segment 12b₁, 12b₂. The second side wall segment 14b₂ may be attached to and extend away from a second end 12a₁″″, 12a₂″″, 12a₃″″, 12b₁″″, 12b₂″″ of each of the first, second and third pervious platform segments 12a₁, 12a₂, 12a₃ and the first and second fluid-collecting trough segment 12b₁, 12b₂.

Referring to FIGS. 1-2, the pair of side wall segments 14b generally define an opening or passage 24 along the proximal end 12a₃″ of the third pervious platform segment 12a₃ of the at least one pervious platform segment 12a of the plurality of vehicle supporting floor segments 12. The opening or passage 24 is directly opposite the distal wall segment 14a. As a result, the distal wall segment 14a and the pair of side wall segments 14b generally define the vehicle wash rack 10 to be ‘partially enclosed;’ therefore, a vehicle (not shown) may be said to ‘enter’ and ‘exit’ the vehicle wash rack 10 at the opening or passage 24.

As seen in, for example, FIGS. 1-2, the opening or passage 24 is formed as a result of a wall segment not being attached to or extending away from the proximal end 12a₃″ of the third pervious platform segment 12a₃ of the at least one pervious platform segment 12a of the plurality of vehicle supporting floor segments 12. The opening or passage 24 permits a vehicle (not shown) to ‘enter’ or ‘exit’ the vehicle wash rack 10. In some implementations, a ramp, R, may be disposed adjacent the thickness, T, of the frame member 18 and along at least a portion of the proximal end 12a₃″ of the third pervious platform segment 12a₃ of the at least one pervious platform segment 12a of the plurality of vehicle supporting floor segments 12 in order to permit the vehicle to ‘enter’/‘exit’ the vehicle wash rack 10.

Referring to FIG. 1, in an implementation, one or more of the distal wall segment 14a and the pair of side wall segments 14b of the plurality of fluid overspray containment wall segments 14 may include at least one vehicle side fluid spraying nozzle 26 that directs fluid toward one or more sides of a vehicle (not shown) and/or wheels of the vehicle. In an example, each of: the distal wall segment 14a, the first side wall segment 14b₁ and the second side wall segment 14b₂ include an upper fluid conduit 28a and a lower fluid conduit 28b; each of the upper fluid conduit 28a and the lower fluid conduit 28b may include, for example, a row of eight vehicle side fluid spraying nozzles 26.

Fluid may be directed through each of the upper fluid conduit 28a and the lower fluid conduit 28b and out of the vehicle side fluid spraying nozzles 26 attached thereto. Once the fluid is directed out of the vehicle side fluid spraying nozzles 26, the fluid may be disposed upon a side of a vehicle and/or wheels of the vehicle. Fluid that does not impinge upon a side of the vehicle and/or wheels of the vehicle, or, alternatively, fluid that deflects off of the side of the vehicle and/or wheels of the vehicle may be contained within the vehicle wash rack 10 by the plurality of fluid overspray containment wall segments 14.

In an example, if a vehicle enters the vehicle wash rack 10 by being driven forwardly through the opening or passage 24, the vehicle side fluid spraying nozzles 26 of the upper fluid conduit 28a and the lower fluid conduit 28b attached to the distal wall segment 14a may direct a fluid toward a front side of the vehicle and/or wheels of the vehicle. In another example, if a vehicle enters the vehicle wash rack by being driven in reverse (i.e., by being backed through the opening or passage 24, the vehicle side fluid spraying nozzles 26 of the upper fluid conduit 28a and the lower fluid conduit 28b attached to the distal wall segment 14a may direct a fluid toward a rear side of the vehicle. Depending on if the vehicle is driven forward or backed through the opening or passages 24, the vehicle side fluid spraying nozzles 26 of the upper fluid conduit 28a and the lower fluid conduit 28b attached to the first side wall segment 14b₁ and the second side wall segment 14b₂ may direct a fluid toward the left and right sides of the vehicle and/or wheels of the vehicle.

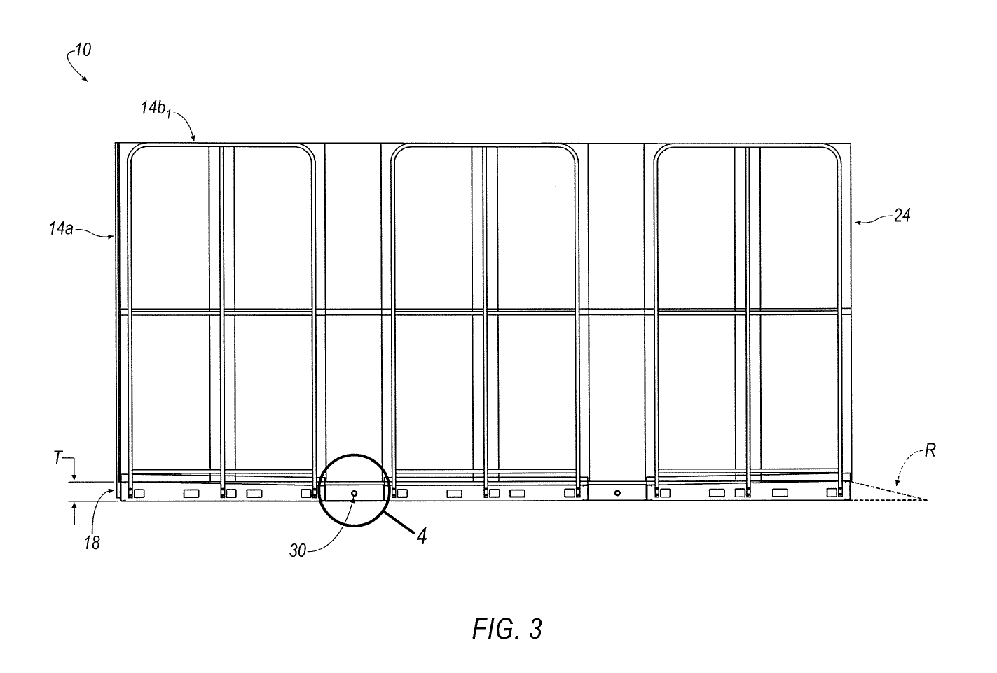

Referring to FIGS. 1 and 3-3, a fluid-supplying conduit 30 may be formed in the thickness, T, of the frame member 18. The fluid-supplying conduit 30 permits the fluid handling system 16 to be fluidly-connected to both of the plurality of vehicle supporting floor segments 12 and the plurality of fluid overspray containment wall segments 14. For example, the fluid-supplying conduit 30 may be fluidly-coupled to the at least one vehicle undercarriage fluid spraying nozzle 22 for permitting the fluid handling system 16 to supply fluid to the plurality of vehicle supporting floor segments 12a of the plurality of vehicle supporting floor segments 12 for directing the fluid toward the undercarriage of the vehicle. In another example, the fluid-supplying conduit 30 may be fluidly-coupled to the at least one vehicle side fluid spraying nozzle 26 for permitting the fluid handling system 16 to supply fluid to the plurality of fluid overspray containment wall segments 14 for directing the fluid toward one or more sides of the vehicle and/or wheels of the vehicle.

Referring to FIG. 1, in an implementation, the fluid handling system 16 may include, for example, a first fluid container 16a, a second fluid container 16b and a pump device 16c. In an implementation, the first fluid container 16a may include a cleaning solvent/solution that is delivered by the nozzles 22, 26 toward a vehicle for cleaning one or more of the undercarriages and/or sides of the vehicle. In an implementation, the second fluid container 16b may receive fluid that was delivered from the nozzles 22, 26 and subsequently directed to the at least one fluid-collecting trough segment 12b. Accordingly, the first fluid container 16a may be referred to as a cleaning solvent/solution holding tank whereas the second fluid container 16b may be referred to as a recovered cleaning solvent/solution holding tank.

Although a first fluid container 16a and a second fluid container 16b are shown and described in the present disclosure, an embodiment of the invention may include one fluid container 16a. In an embodiment where one fluid container 16a is included in the design of the vehicle wash rack 10, the vehicle wash rack 10 may include one or more fluid filters (not shown) that filters fluid received by the at least one fluid-collecting trough segment 12b; accordingly, once the fluid has been filtered of any impurities (e.g., dirt, dust, sand, oil or the like) that was removed from the undercarriage and/or one or more sides of the vehicle, the filtered fluid may be recycled for subsequent use by being returned to the one fluid container 16a (rather than being directed to a second fluid container 16b that retains non-filtered, recovered cleaning solvent/solution).

Referring to FIG. 1, the pump device 16c may include one or more pumps 32. In an example, the one or more pumps 32 may be utilized for delivering fluid from the first fluid container 16a to the nozzles 22, 26. In another example, the one or more pumps 32 may be utilized for drawing fluid from the at least one fluid-collecting trough segment 12b toward one or more of the first fluid container 16a and the second fluid container 16b.

The pump device 16c may further comprise a computing device 34 including one or more of a processor (not shown) and memory (not shown) for executing a computer program that controls operation of the one or more pumps 32 and/or one or more valves (not shown). In an implementation, the one or more valves may include one or more solenoid actuated valves. The computer program may be operated in a manner in order to selectively control one or more of the flow rate and pressure of the fluid delivered to/from one or more of the first fluid container 16a and the second fluid container 16b.

Another aspect of the computer program may include control of one or more of the valves (not shown) for sequencing of the nozzles 22, 26 in order to selectively control actuation of/fluid jetting from the nozzles 22, 26 such that some of the nozzles 22, 26 dispense the fluid for a selected period of time whereas some of the nozzles 22, 26 do not dispense the fluid for a selected period of time. For example, the sequencing of the nozzles 22, 26 may include successive de/actuation of one or more valves associated with, for example, each column and/or row of vehicle undercarriage fluid spraying nozzles 22. Another example of the sequencing of the nozzles 22, 26 may include firstly de/actuation of one or more valves associated with, for example, the vehicle side fluid spraying nozzles 26 of the upper fluid conduit 28a followed by secondly de/actuation of one or more valves associated with, for example, the vehicle side fluid spraying nozzles 26 of the lower fluid conduit 28b. In yet another example of the sequencing of the nozzles 22, 26 may include firstly de/actuation of one or more valves associated with, for example, the vehicle side fluid spraying nozzles 26 of the distal wall segment 14a and the at least one pervious platform segment 12a followed by secondly de/actuation of one or more valves associated with, for example, the vehicle side fluid spraying nozzles 26 of the pair of side wall segments 14b. Accordingly, it will be appreciated that any desirable sequencing of the nozzles 22, 26 may be included as a result of the computer program of the pump device 16c de/actuating of one or more valves (not shown) of the vehicle wash rack 10.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A vehicle wash rack comprising:
a plurality of vehicle supporting floor segments;
a plurality of fluid overspray containment wall segments; and
a fluid handling system fluidly-connected to both of the plurality of vehicle supporting floor segments and the plurality of fluid overspray containment wall segments.

2. The vehicle wash rack of claim 1, wherein the plurality of vehicle supporting floor segments include:
at least one platform segment; and
at least one fluid-collecting trough segment.

3. The vehicle wash rack of claim 2, wherein the at least one platform segment includes:
a first platform segment,
a second platform segment, and
a third platform segment.

4. The vehicle wash rack of claim 3, wherein the at least one fluid-collecting trough segment includes:
a first fluid-collecting trough segment, and
a second fluid-collecting trough segment, wherein the first fluid-collecting trough segment is disposed between the first platform segment and the second platform segment, wherein the second fluid-collecting trough segment is disposed between the second platform segment and the third platform segment.

5. The vehicle wash rack of claim 4, wherein a distal end of the first platform segment is arranged at a higher elevation than the proximal end of the first platform segment in order to arrange the first platform segment at a pitched angle for directing fluid into the first fluid-collecting trough segment, wherein a proximal end of the third platform segment is arranged at a higher elevation a the distal end of the third platform segment in order to arrange the third platform segment at a pitched angle for directing fluid into the second fluid-collecting trough segment.

6. The vehicle wash rack of claim 4, wherein one or more of the first, second and third platform segments of the at least one platform segment of the plurality of vehicle supporting floor segments may form at least one perforation for permitting fluid to flow through one or more of the first, second and third platform segment of the at least one platform segment of the plurality of vehicle supporting floor segments, wherein the at least one perforation is in fluid communication with one or more of the first fluid-collecting trough segment and the second fluid-collecting trough segment.

7. The vehicle wash rack of claim 3, wherein one or more of the first, second and third platform segments of the at least one platform segment includes
at least one vehicle undercarriage fluid spraying nozzle that directs fluid toward an undercarriage of a vehicle.

8. The vehicle wash rack of claim 3, wherein the first and second platform segments of the at least one platform segment each includes a plurality of vehicle undercarriage fluid spraying nozzles that are arranged in a substantially grid-shaped pattern.

9. The vehicle wash rack of claim 8, wherein the first platform segment includes a grid-shaped pattern of vehicle undercarriage fluid spraying nozzles defined by four columns and eight rows of vehicle undercarriage fluid spraying nozzles.

10. The vehicle wash rack of claim 8, wherein the second platform segment includes a grid-shaped pattern of vehicle undercarriage fluid spraying nozzles defined by three columns and eight rows of vehicle undercarriage fluid spraying nozzles.

11. The vehicle wash rack of claim 1, wherein the plurality of fluid overspray containment wall segments are supported by and extend away from the plurality of vehicle supporting floor segments.

12. The vehicle wash rack of claim 4, wherein the plurality of fluid overspray containment wall segments include:
a distal wall segment, and
a pair of side wall segments defined by
a first side wall segment, and
a second side wall segment.

13. The vehicle wash rack of claim 12, wherein the distal wall segment is attached to and extends away from a distal end of the first platform segment of the at least one platform segment of the plurality of vehicle supporting floor segments, wherein the first side wall segment is attached to and extends away from a first end of each of the first, second and third platform segments and the first and second fluid-collecting trough segments of the of the plurality of vehicle supporting floor segments, wherein the second side wall segment is attached to and extends away from a second end of each of the first, second and third platform segments and the first and second fluid-collecting trough segment of the plurality of vehicle supporting floor segments.

14. The vehicle wash rack of claim 12, wherein the pair of side wall segments define an opening or passage along a proximal end of the third platform segment of the at least one platform segment of the plurality of vehicle supporting floor segments.

15. The vehicle wash rack of claim 12, wherein one or more of the distal wall segment and the pair of side wall segments of the plurality of fluid overspray containment wall segments includes at least one vehicle side fluid spraying nozzle that directs fluid toward one or more sides of a vehicle and/or wheels of the vehicle.

16. The vehicle wash rack of claim 15, wherein each of: the distal wall segment, the first side wall segment and the second side wall segment includes
an upper fluid conduit, and
a lower fluid conduit, wherein each of the upper fluid conduit and the lower fluid conduit includes a plurality of vehicle side fluid spraying nozzles arranged in a row.

17. The vehicle wash rack of claim 1, wherein the plurality of vehicle supporting floor segments are supported by a frame member.

18. The vehicle wash rack of claim 18 further comprising
a fluid-supplying conduit formed in a thickness of the frame member, wherein the fluid-supplying conduit fluidly-couples the fluid handling system to both of
at least one vehicle undercarriage fluid spraying nozzle attached to the plurality of vehicle supporting floor segments, and
at least one vehicle side fluid spraying nozzle attached to the plurality of fluid overspray containment wall segments.

19. The vehicle wash rack of claim 18, wherein the fluid handling system includes
at least one first fluid container, and
a pump device including one or more pumps and one or more valves.

20. The vehicle wash rack of claim 19, wherein a first fluid container of the at least one first fluid container contains a cleaning solvent that is delivered to one or more of the at least one vehicle undercarriage fluid spraying nozzle and the at least one vehicle side fluid spraying nozzle by the pump device.

21. The vehicle wash rack of claim 19, wherein the pump device includes a computing device that controls one or more of the one or more pumps and the one or more valves.

22. The vehicle wash rack of claim 20, wherein a second fluid container of the at least one first fluid container receives a recovered cleaning solvent from the plurality of vehicle supporting floor segments after the cleaning solvent impacts one or more of an undercarriage and one or more sides of a dirty vehicle, wherein the recovered cleaning solvent is delivered to the second fluid container by the pump device.

23. The vehicle wash rack of claim 20, wherein the computing device controls the one or more pumps for controlling a flow rate of the cleaning solvent jetted from one or more of the at least one vehicle undercarriage fluid spraying nozzle attached to the plurality of vehicle supporting floor segments and the at least one vehicle side fluid spraying nozzle attached to the plurality of fluid overspray containment wall segments.

24. The vehicle wash rack of claim 20, wherein the computing device controls the one or more pumps for controlling a fluid pressure of the cleaning solvent jetted from one or more of the at least one vehicle undercarriage fluid spraying nozzle attached to the plurality of vehicle supporting floor segments and the at least one vehicle side fluid spraying nozzle attached to the plurality of fluid overspray containment wall segments.

25. The vehicle wash rack of claim 20, wherein the computing device controls the one or more valves for controlling a sequencing of the one or more of the at least one vehicle undercarriage fluid spraying nozzle attached to the plurality of vehicle supporting floor segments and the at least one vehicle side fluid spraying nozzle attached to the plurality of fluid overspray containment wall segments.
